(19) United States
(12) Patent Application Publication
(10) Pub. No.: US 2024/0275741 A1
(43) Pub. Date: Aug. 15, 2024

(54) EXECUTION OF MULTIPLE DISTINCT PIPELINES IN A SINGLE NETWORK DEVICE

(71) Applicant: Arista Networks, Inc., Santa Clara, CA (US)

(72) Inventors: Navdeep Bhatia, Sunnyvale, CA (US); Michael Chih-Yen Wang, Vancouver (CA); Hugh Weber Holbrook, Palo Alto, CA (US); Prasanna Parthasarathy, Cupertino, CA (US)

(21) Appl. No.: 18/167,287

(22) Filed: Feb. 10, 2023

(51) Int. Cl. H04L 49/00; H04L 12/46; H04L 49/9057

(52) U.S. Cl. CPC H04L 49/3063; H04L 12/4641; H04L 49/9057

(57) ABSTRACT

Embodiments as disclosed herein allow packets to be efficiently forwarded between distinct forwarding pipelines in a network device, such as forwarding pipelines configured according to a standard program provided with the network device or a custom program implemented by a user of the network device. In particular, packets can be forwarded between forwarding pipelines configured according to different programs using recirculation ports associated with each pipeline.

### BACKGROUND

Network devices (such as switches, routers, etc.) control the flow of packets into and out of the device. Typically, these network devices implement a forwarding pipeline for such packet flow control. These forwarding pipelines are usually separated into two portions, an ingress portion of the pipeline and an egress portion of the pipeline. In most cases forwarding pipelines on network devices are implemented utilizing a processor such as a Central Processing Unit (CPU), Field Programmable Gate Array (FPGA), or Application-Specific Integrated Circuit (ASIC) so that the forwarding pipeline can be implemented as part of a packet processor realized as a System on a Chip (SoC) or the like.

Many modern processors utilized in the implementation of forwarding pipelines in network devices offer the ability to program such forwarding pipelines. Accordingly, multiple forwarding pipelines may be implemented on processors used in network devices.

Thus, what is desired is to allow differently programmed forwarding pipelines within a single network device to easily forward packets between one another so that these packets can be efficiently processed by the different pipelines.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a block diagram illustrating the use of a programmable pipeline in a network device.

FIG. 2 is a block diagram illustrating the use of multiple pipelines in a network device.

FIG. 3 is a block diagram of an embodiment of a network device adapted to forward packets between multiple distinct pipelines.

FIGS. 4A-4D are block diagrams of embodiments of a network device adapted to forward packets between multiple distinct pipelines.

FIG. 5 is a block diagram of an embodiment of a forwarding pipeline in a network device for forwarding packets between multiple distinct pipelines.

FIG. 6 is a flow diagram of one embodiment of a method for forwarding packets between multiple distinct pipelines in a network device.

### DETAILED DESCRIPTION

As discussed, a network device (such as a switch, a router, etc.) controls the flow of packets into and out of the device. Typically, these network devices implement a forwarding pipeline for such packet flow control. These forwarding pipelines are usually separated into two portions, an ingress portion of the pipeline and an egress portion of the pipeline. Many modern processors utilized in the implementation of forwarding pipelines in network devices offer the ability to program such forwarding pipelines. A pipeline program can be written and used to configure stages of the forwarding pipeline according to the program. For example, P4 is a language for expressing how packets are to be processed by the data plane of a programmable network device. P4 programs thus specify how various blocks (also referred to as stages or units) of a forwarding pipeline are programmed and connected. Accordingly, providers of network devices (e.g., manufacturers) typically write their own forwarding pipeline for a network device, and this provided (or “standard”) forwarding pipeline can be utilized by users of the network device. Alternatively, users of these network devices may compose their own custom forwarding pipeline program to configure the processor of the network device to implement a custom forwarding pipeline.

Recently, a trend has been to provide the ability to implement multiple forwarding pipelines on processors used in network devices. In large part the use of these multiple pipelines is driven by a desire to increase the throughput (e.g., packet processing rate) of network devices. A straightforward way to achieve such an increase in packet processing throughput is to utilize multiple pipelines to process packets in parallel. When utilizing multiple pipelines in a network device it is common to assign multiple physical ports of the network device to each pipeline. For example, a network device with 32 ports might assign ports 0 through 15 to pipeline 0, and ports 16 through 31 to pipeline 1. All packets received on ports 0 through 15 will be processed by the ingress portion of pipeline 0, then (if they were not dropped when being processed by ingress pipeline 0) the packet may be forwarded to egress pipeline 0 if the ingress pipeline forwarded the packet to port 0 through 15, or forwarded to egress pipeline 1 if the ingress pipeline forwarded the packet to port 16 through 31.

In such a device it is also typical that each of the multiple pipelines is programmed in the same manner (e.g., the same P4 program is used to configure each of the forwarding pipelines). In other words, it is usually the case that either a standard pipeline (e.g., provided with the network device) is selected to configure each of the multiple pipelines of the network device, or a user of the network device programs their own custom forwarding pipeline and configures the multiple pipelines of the network device according to that custom pipeline.

It is often the case, however, that users of network devices wish to implement certain custom functionality with respect to a forwarding pipeline while still utilizing functionality of the standard pipeline provided with a network device. This capability would allow users of network devices to develop custom forwarding pipeline programs to implement desired proprietary functionality without having to perform duplicative programming for portions of the forwarding pipeline that are provided as part of the standard forwarding pipeline. Such a capability would therefore reduce both the cost and complexity of developing or using a custom forwarding pipeline.

Currently, allowing two or more different forwarding pipelines (e.g., two or more pipelines configured according to different programs) to interact when performing packet forwarding is quite difficult. There are two main approaches to allowing forwarding pipelines to interact, both deficient for their own reasons. The first involves tightly integrating the two pipelines (or particular portions or functionality of these pipelines). Such a tight degree of integration requires tailoring the programming of each of the pipelines to one another so each of the programs for the pipelines is adapted specifically for the other pipeline with which it is to be integrated. As may be realized, such a solution is highly problematic, as it is often a goal of such forwarding pipelines to be as widely applicable as possible. In particular, providers of network devices may desire that a standard pipeline provided with a network device be as generic as possible.

Another solution to integrating different pipelines is to implement the different pipelines on different network devices coupled to one another through their network interfaces (ports), referred to as back-to-back devices. In this way packets may be processed through one forwarding pipeline at one network device and forwarded through a port to the other network device where the packet can be processed by the other forwarding pipeline. In some cases, the packet may then be forwarded back to the first network device through a port of the other network device for further processing by the first forwarding pipeline. Such solutions are also inadequate. As but one problem, these solutions waste resources, as at least two distinct network devices may be required, with attendant costs associated with the interconnection, cabling, transceivers, power, and management overhead. Furthermore, these types of solutions limit the amount of interaction that the two pipelines may have, as each packet may need to be fully processed by both pipelines in such a configuration.

Thus, what is desired is to allow differently programmed forwarding pipelines within a single network device to easily forward packets between one another so that these packets can be efficiently processed by the different pipelines. Such a capability may allow differently programmed forwarding pipelines to easily forward packets between one another so that these packets can be efficiently processed by the different pipelines. For example, it may be desired that a standard pipeline provided with a network device be used for certain aspects of forwarding, routing, or management, while still allowing a custom forwarding pipeline to be applied to a packet to implement custom functionality desired by users of a network device.

To address these desires, among others, embodiments as disclosed herein allow packets (including partially processed packets) to be efficiently forwarded (e.g., within the network device or using external ports) between differently configured forwarding pipelines in a network device, such as a standard program provided with the network device, or a custom program implemented by a user of the network device. Specifically, embodiments may forward packets between forwarding pipelines configured according to different programs using recirculation ports associated with each pipeline. A recirculation port associated with a pipeline is a port configured such that packets transmitted out that recirculation ports are forwarded back to the ingress portion of the associated pipeline. These recirculation ports can be internal recirculation ports or may be dedicated or configured loopback ports of the network device. For example, such loopback ports may utilize external cables or media access control (MAC) addresses put in loopback mode, etc. Internal recirculation ports may, on the other hand, be require no cabling (e.g., without any physical user intervention such as inserting a loopback connector or loopback cable) or may be achieved through programmatic configuration of the device.

In any event, a packet received at the network device can be forwarded to an ingress portion of a (e.g., initial) pipeline for processing (such as a standard pipeline or the like). During processing of that packet by the initial pipeline, it can be determined that the packet is to be forwarded to another (subsequent) pipeline in the network device (e.g., configured according to a different pipeline program, such as a custom program created by a user of the network device). The ingress portion of the initial pipeline processing the packet can then forward the packet to the subsequent pipeline by forwarding the packet to the recirculation port of this subsequent pipeline, causing the packet to be forwarded from this recirculation port to the ingress portion of the subsequent pipeline, and thus allowing this subsequent pipeline to process the forwarded packet.

To assist the subsequent pipeline in processing the packet, data associated with the packet may be appended to the packet by the initial pipeline before it is forwarded to the recirculation port of the subsequent pipeline. For example, the initial pipeline may append a header including this associated data to the packet, where the associated data may include, for example, data identifying an ingress port associated with the packet, a forwarding domain identifier (e.g., such as a virtual local area network (VLAN) associated with the packet), or a classification tag associated with the packet.

According to one embodiment, match action units within a pipeline may be used to forward packets between these different pipelines. To illustrate in more detail, in some instances programmable pipelines comprise programmable match action units for implementing the pipeline. A match action unit may include logic and lookup tables that are used to make forwarding or packet rewriting decisions. Thus, in certain embodiments, a match action unit of the initial pipeline can include a table comprising an entry specifying an action associated with an identifier for the recirculation port of the subsequent pipeline. This identifier may be, for example, a link aggregation group (LAG) identifier associated with one or more recirculation ports. A key is formed based on data associated with a packet undergoing processing by the pipeline. The match action unit performs a lookup in the table based on the formed key. When a lookup in this table is a match for the entry, the packet can be forwarded to the recirculation port for the subsequent pipeline based on the identifier for that recirculation port specified in the action of the determined entry, allowing the subsequent pipeline to process the packet.

When the subsequent pipeline is done processing the packet it can be forwarded directly to an egress port of the network device (e.g., through an egress portion of the initial pipeline). Alternatively, in another embodiment, it may be desirable to forward the packet from this subsequent pipeline back to the (e.g., ingress portion of the) initial pipeline. For example, it may be desired to forward a packet from a custom pipeline to which the packet was forwarded by a standard pipeline back to the standard pipeline to take advantage of functionality implemented by the standard pipeline. Here, the subsequent pipeline can forward the packet to a recirculation port associated with the initial pipeline so the packet can be forwarded to the ingress portion of the initial pipeline for processing (e.g., for a second time). Again, to assist the initial pipeline in processing the packet, data associated with the packet may be appended to the packet by the subsequent pipeline before it is forwarded back to the initial pipeline. This data may be included in a reply header or the like that includes, for example, a forwarding domain identifier (e.g., a VLAN encapsulation tag) or a re-run indicator indicating whether the packet should (or should not) be run again through all, or certain stages of, the ingress portion of the initial pipeline.

Embodiments may thus have the advantage of allowing multiple (e.g., independently developed) pipeline programs to be utilized together for packet forwarding in a single network device, as substantial knowledge of the different pipeline programs is not required to integrate these pipeline programs. Specifically, in the context of integrating a user developed custom pipeline program with a standard pipeline, these custom pipelines may be developed to focus on only the desired functionality of that custom pipeline while still being able to take advantage of the full set of forwarding (or other) features offered by the standard pipeline provided with the network device.

Moreover, as these custom pipelines may operate substantially independently from a standard pipeline (or one another), each of the custom pipelines may utilize and manage their own set of dedicated resources. As an added benefit, packets undergoing processing by these forwarding pipelines may be modified by both pipelines and processed by each pipeline according to the modified information provided by the other pipeline. Additionally, in instances where it is not desired to have the packet processed by the initial (e.g., standard) pipeline again, the subsequent pipeline may forward packets directly out the ports of the network device. As another advantage, all pipelines utilized in the processing of a packet can process the packet as needed (e.g., before or after a packet has been forwarded to or from a pipeline), a capability that cannot usually be realized in other solutions for utilizing custom pipelines (e.g., in a back-to-back arrangement), where the processing of a packet by a custom pipeline is typically always either after the standard pipeline is used for forwarding or after forwarding is applied by the standard pipeline. This flexibility to chain the custom and standard pipelines together is another advantage of embodiments disclosed, compared to the traditional approach of tightly integrated pipelines.

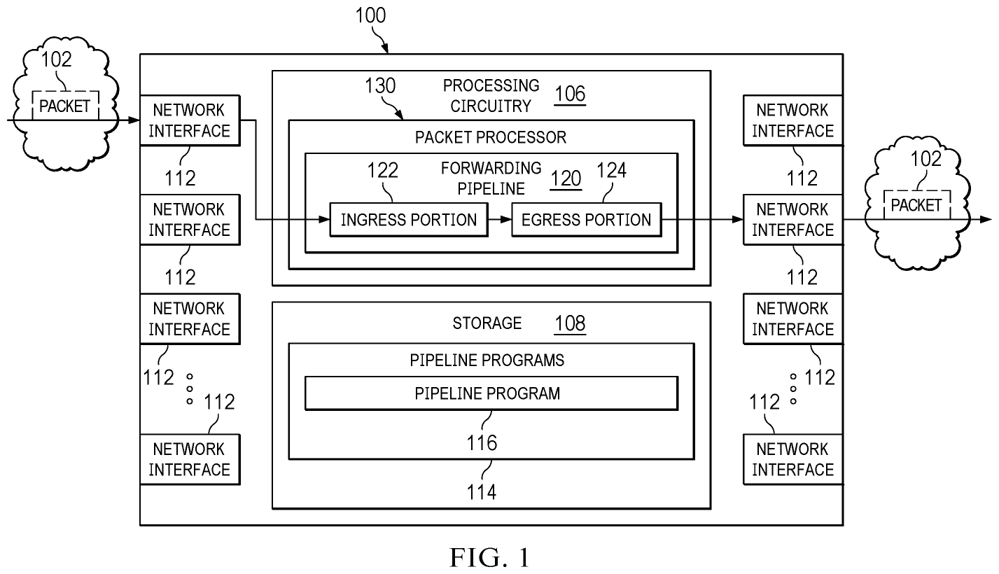

Before describing embodiments in more detail, It may be helpful to have an understanding of embodiments to discuss the operation of pipelines in network devices generally. Referring first to FIG. 1, a network device 100 (such as a switch, router, Network Interface Card (NIC), etc.) comprises a plurality of network interfaces 112 (also referred to as ports) to which hosts may be connected (e.g., through a wired or wireless connection) to access a network. Specifically, the network device 100 controls the flow of packets 102 received from hosts through network interfaces 112 into and out of network device 100 and onto the network.

Network device 100 implements forwarding pipeline 120 for such packet flow control. Forwarding pipeline 120 includes an ingress portion 122 and an egress portion 124 for routing packets 102 from and to the network. The forwarding pipeline 120 is implemented on the processing circuitry 106 of the network device 100. In particular, the processing circuitry 106 may include a packet processor 130 such as a CPU, FPGA, or ASIC. Packet processor 130 may be programmable such that a pipeline program 116 can be written and used to configure stages of the forwarding pipeline according to the program. In many cases, a pipeline program 116 adapted to configure stages of the ingress portion 122 and egress portion 124 of the forwarding pipeline 120 may be written and stored in storage 108 of the network device 100 in an area 114 of the storage 108 utilized for pipeline programs 114. The pipeline program 116 can then be compiled and used to configure the packet processor 130 to implement forwarding pipeline 120 as defined in the pipeline program 116. As but one example, P4 is a language for expressing how packets are to be processed by the data plane of a programmable network device. P4 programs thus specify how various blocks (or units) of forwarding pipeline 120 are programmed and connected.

Providers of network device 100 (e.g., manufacturers) may provide forwarding pipeline program 116 with the network device 100 (e.g., it may be stored in storage 108 when the network device 100 is provided to a user) such that this provided (or “standard”) forwarding pipeline program 116 can be utilized by users of the network device. Users of network device 100 may also compose their own custom forwarding pipeline program 116 to implement a custom forwarding pipeline 120.

In any case, when a packet 102 is received at network device 100 from a host through a network interface 112 it may be processed by the network device 100 using forwarding pipeline 120 programmed according to pipeline program 116. Thus, when the packet 102 is received by the network device 100 through network interface 112, it is forwarded to the ingress portion 122 of the forwarding pipeline 120 for processing. The packet is then forwarded by the ingress portion 122 to the egress portion 124 for further processing (e.g., if the packet 102 is not dropped or otherwise disposed of). Egress portion 124 of the forwarding pipeline 120 can then process the packet 102 and forward the packet 102 to a destination over an appropriate network interface 112 (again, if the packet 102 is not dropped or otherwise disposed of).

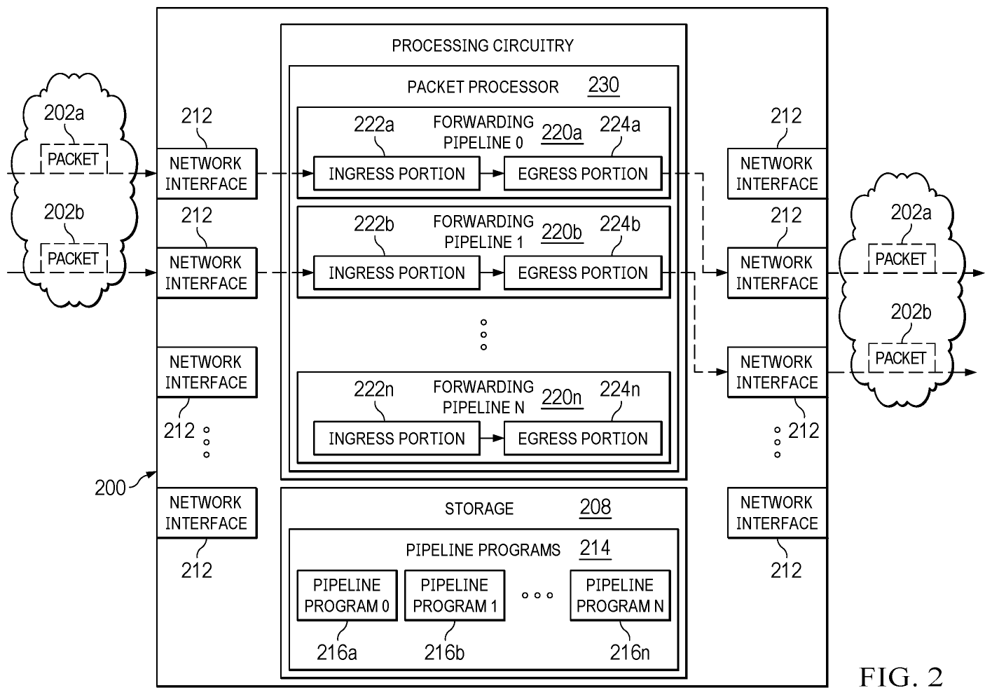

As mentioned previously, some programmable packet processors offer the ability to implement multiple forwarding pipelines. Moving then to FIG. 2, a network device implementing multiple forwarding pipelines is depicted. Here, network device 200 implements forwarding pipelines 220a, 220b, 220n executing on packet processor 230 for packet flow control, where each forwarding pipeline 220a, 220b, 220n comprises its own respective ingress portion 222a, 222b, 222n and egress portion 224a, 224b, 224n. Network device 200 can thus control the flow of packets 202 received from hosts through network interfaces 212 into and out of network device 200 and onto the network using forwarding pipelines 220.

There may be multiple pipeline programs 216 that may be utilized to configure the forwarding pipelines 220 of the network device 200. Each of these pipeline programs 216 may be stored in an area 214 of storage 208 for storing such pipeline programs 216 and may be a standard forwarding pipeline program (e.g., provided by a manufacturer of the network device 200) or a custom forwarding pipeline program written by a user of the network device (or written by third party or other entity). For example, a first pipeline program 216a may be a standard pipeline program provided with the network device 200 while other pipeline programs 216b, 216n may be custom forwarding pipeline programs.

Typically, each of the multiple forwarding pipelines 220a, 220b, 220n is programmed according to the same pipeline program 216. In other words, it is usually the case that either a standard pipeline program (e.g., pipeline program 216a provided with the network device 200) is selected to configure each of the multiple forwarding pipelines 220a, 220b, 220n of the network device 200, or a custom forwarding pipeline (e.g., either pipeline program or pipeline program 216b, 216n) is selected to configure each of the multiple pipelines 220a, 220b, 220n of the network device 200 according to that selected custom pipeline.

In any case, when a packet 202 is received at network device 200 from a host through a network interface 212, it may be processed by the network device 200 using a forwarding pipeline 220 programmed according to the pipeline program 216 selected for programming the forwarding pipeline 220. While the use of multiple forwarding pipelines 220 may increase the throughput of packets 202 relative to the use of single forwarding pipeline 220, each of the forwarding pipelines 220 processes each of the packets in the same manner (e.g., using equivalently programmed forwarding pipelines 220). For example, packet 202a may be received by the network device 200 through network interface 212 and forwarded to forwarding pipeline 220a for processing, while packet 202b may be received through network interface 212 and forwarded to forwarding pipeline 220b for processing, where both forwarding pipelines 220a, 220b are configured according to the same pipeline program 216.

Users of network devices often desire to implement certain custom functionality with respect to a forwarding pipeline while still utilizing functionality of a standard pipeline provided with a network device. This capability may allow users of network devices to develop custom forwarding pipeline programs to implement desired proprietary functionality without having to perform duplicative programming for portions of the forwarding pipeline that are provided as part of the standard forwarding pipeline. Such a capability would therefore reduce both the cost and complexity of developing or using a custom forwarding pipeline.

Embodiments as disclosed may thus allow differently programmed forwarding pipelines to efficiently forward packets (including partially processed packets) between one another so that these packets can be efficiently and flexibly processed by the different pipelines. For example, it may be desired that a standard pipeline provided with a network device be used for certain aspects of forwarding, routing, or management, while still allowing a custom forwarding pipeline to be applied to a packet to implement custom functionality desired by users of a network device.

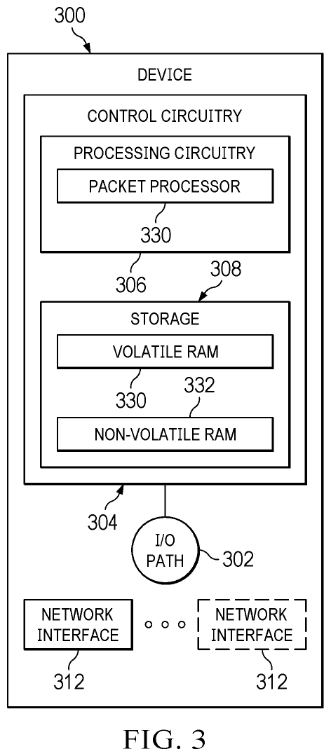

FIG. 3 is a block diagram depicting a general architecture of a network device for efficient forwarding of packets between differently configured forwarding pipelines in accordance with certain embodiments. Network device 300 may be a router, switch, server, NIC, or any other computing device that may be configured to control or process network traffic. The network device 300 may receive data, including packets from hosts (not shown), via an input/output (I/O) path 302. I/O path 302 may provide packet data to control circuitry 304, which includes processing circuitry 306 and storage (i.e., memory) 308. Control circuitry 304 may send and receive commands, requests, and other suitable data using I/O path 302. I/O path 302 may connect control circuitry 304 (and specifically processing circuitry 306) to one or more network interfaces 312 to which other devices of a network (e.g., hosts) can be connected. These network interfaces 312 may be any type of network interface, such as an RJ45 ethernet port, a coaxial port, a small form factor pluggable interface, etc.

Control circuitry 304 includes processing circuitry 306 and storage 308. As referred to herein, processing circuitry should be understood to mean circuitry based on one or more microprocessors, microcontrollers, digital signal processors, programmable logic devices, field-programmable gate arrays (FPGAs), ASICs, etc., and may include a multi-core processor (e.g., dual-core, quad-core, hexa-core, octa-core, or any suitable number of cores). In some embodiments, processing circuitry 306 is distributed across multiple separate processors or processing units, for example, multiple of the same type of processing units. The circuitry described herein may execute instructions included in software running on one or more general purpose or specialized processors.

Storage 308 may be an electronic storage device that includes volatile random-access memory (RAM) 330, which does not retain its contents when power is turned off, and non-volatile RAM 332, which does retain its contents when power is turned off. As referred to herein, the phrase “storage,” “memory,” “electronic storage device,” or “storage device” should be understood to mean any device for storing electronic data, computer software, instructions, or firmware, such as certain integrated circuit storage (e.g., flash memory, random access memory (RAM), dynamic RAM (DRAM), static RAM (SRAM), resistive RAM (ReRAM), etc.), content-addressable memory (CAM), hard drives, optical drives, solid state devices, quantum storage devices, or any other suitable fixed or removable storage devices, or any combination of the same. For example, a persistent memory module that includes a combination of DRAM, flash memory, and a capacitor (for persisting DRAM data to flash memory in the event of power loss) is considered “storage”.

Processing circuitry 306 may include a packet processor 330 such as a switching ASIC or the like. According to embodiments, packet processor 330 implements a programmable forwarding pipeline architecture such as the Intel® Tofino™ Ethernet switch ASIC (Intel® and Tofino™ belong to the registered owners of the marks and no claim is made herein to ownership of these marks). This is a match action pipeline architecture in which subsets of data bits in the packet are matched against tables, where the matched entries in the tables specify corresponding actions that are applied to the packet. Other embodiments of the processing circuitry could be a network processor that executes code or microcode on one more threads, a multi-core or multi-threaded general purpose CPU with associated memory and/or cache as storage, or any packet processor with multiple pipelines containing flexibly-programmed lookup tables, TCAMs, memories, associative memories, with programmable key construction or result processing engines

Accordingly, in some embodiments, different pipeline programs (e.g., a standard pipeline program and one or more custom pipeline programs) can be stored in storage 308 of the network device 300. Packet processor 330 can thus be configured according to these stored pipeline programs such that the packet processor 330 is adapted to execute multiple differently configured forwarding pipelines. Each of the forwarding pipelines (configured according to their respective pipeline program) may be adapted to forward packets being processed by that pipeline to another forwarding pipeline configured on the packet processor 330.

Specifically, each of the (e.g., differently configured) forwarding pipelines executing on packet processor 330 may be associated with one or more recirculation ports. A recirculation port associated with a forwarding pipeline is a port configured such that packets received at that recirculation port are forwarded to the ingress portion of the associated pipeline. These recirculation ports can be internal recirculation ports or may be dedicated or configured loopback ports (network interfaces) 312 of the network device. For example, such loopback ports may utilize external cables or MAC addresses put in loopback mode, etc.

Consequently, a forwarding pipeline (e.g., a standard pipeline or a custom pipeline as configured using a corresponding pipeline program stored in storage 308) on the packet processor 330 may be adapted to forward packets being processed by that forwarding pipeline to another (e.g., subsequent) forwarding pipeline configured according to a different pipeline program by forwarding the packet to a recirculation port of the subsequent pipeline whereby the packet may be forwarded to the ingress portion of the subsequent forwarding pipeline, or by forwarding the packet to an egress portion of a subsequent pipeline (e.g., after which it may be forwarded to the recirculation port and thereby to the ingress portion of the subsequent forwarding pipeline). As such, an initial forwarding pipeline such as a standard pipeline provided by a manufacturer or other provider of the network device 300, may be used to process a packet received at a network interface 312 of the network device 300 and forward the packet to a subsequent (e.g., custom) pipeline.

In other words, when a packet is received at the network interface 312 it may be initially forwarded to a standard forwarding pipeline executing on the packet processor 330. At some point the initial forwarding pipeline may determine that the packet is to be forwarded to another (subsequent) pipeline. This subsequent pipeline may be, for example, a custom pipeline programmed by, for example, a user or other third party of the network device 300. This determination may happen, for example, during processing of the packet by the ingress portion of the initial pipeline. When this determination is made, the packet can be forwarded to the egress portion of the subsequent pipeline, or to the recirculation port associated with the subsequent pipeline, such that the packet is forwarded to the ingress portion of the subsequent pipeline.

This subsequent pipeline may process the packet through the egress portion of that subsequent pipeline to make a forwarding decision regarding that packet for routing the packet to a destination over an appropriate network interface 312. The subsequent pipeline may also determine that the packet is to be forwarded back to the initial pipeline (e.g., the standard pipeline) for processing by the initial pipeline or may determine that the packet is to be forwarded to yet another (subsequent) pipeline (e.g., another custom pipeline) for further processing.

If the packet is to be forwarded back to the initial pipeline, the packet can be forwarded to the egress portion of the initial pipeline (e.g., for forwarding by the egress portion of the initial pipeline) or to the recirculation port associated with the initial pipeline such that the packet is forwarded to the ingress portion of the initial pipeline. Similarly, if it is determined that the packet is to be forwarded to another subsequent pipeline the packet can be forwarded directly to the recirculation port of the subsequent pipeline (and thence to the ingress portion of the subsequent pipeline). Alternatively, the packet can be forwarded to the egress portion of that subsequent pipeline, after which the packet is forwarded to the recirculation port associated with that subsequent pipeline to be forwarded to the ingress portion of the subsequent pipeline.

Each subsequent pipeline can make similar determinations during the processing of the packet until the packet is forwarded through an egress portion of a forwarding pipeline for forwarding through a network interface 312 (e.g., is forwarded back to the initial pipeline for processing by the egress portion of the initial (e.g., standard) pipeline). In this way, the packet can be forwarded to almost any number of subsequent (e.g., custom) pipelines for processing as desired and may still be forwarded back to the initial (e.g., standard) forwarding pipeline to be processed by the egress portion of the initial pipeline for forwarding.

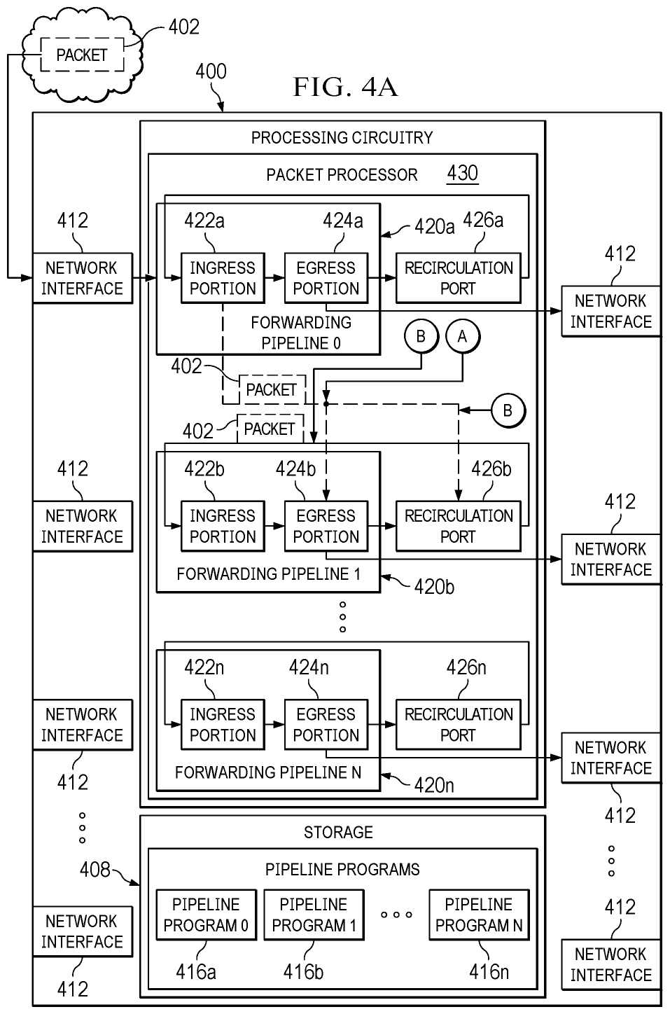

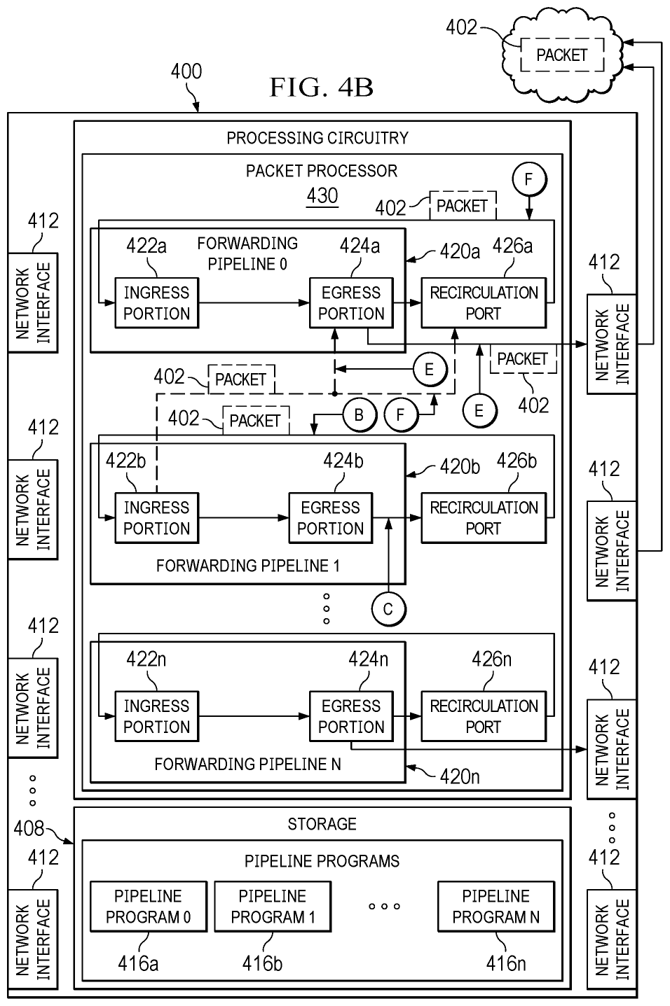

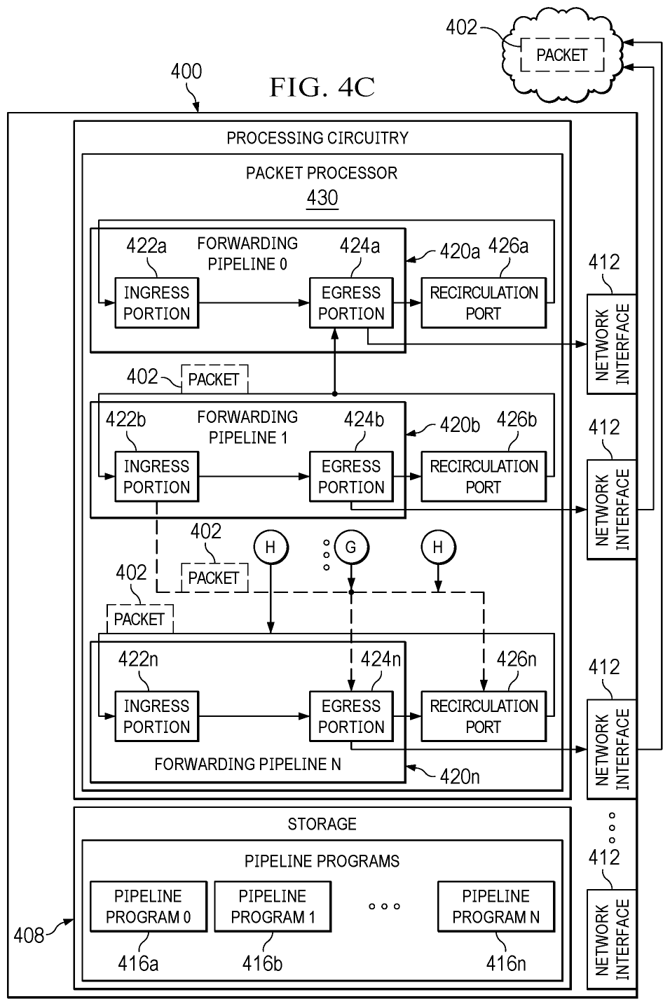

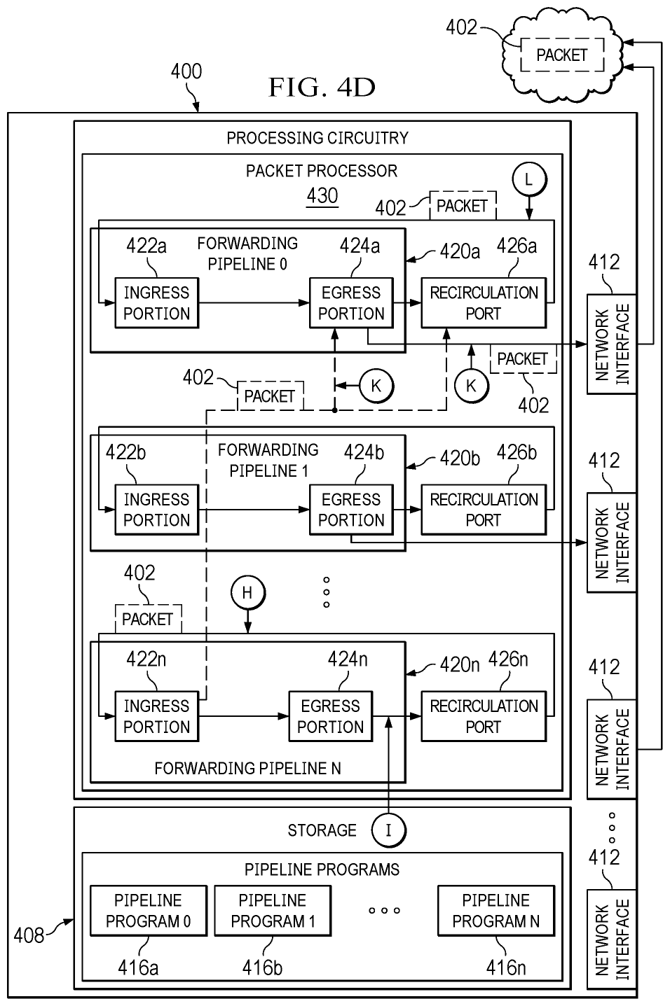

FIGS. 4A-4D depict embodiments of a network device for efficient forwarding of packets between differently configured forwarding pipelines in more detail. Looking initially at FIG. 4A, multiple pipeline programs 416a, 416b, 416n may be stored in storage 408 of the network device 400. For example, pipeline program 416a may be a standard pipeline program provided with network device 400 while pipeline programs 416b, 416n may be custom pipeline programs written or otherwise stored by users of the network device 400. Accordingly, packet processor 430 of the network device 400 executes forwarding pipelines 420 configured according to pipeline programs 416. Each of the forwarding pipelines 420 may be configured according to a different pipeline program 416 (e.g., forwarding pipeline 420a can be configured according to standard pipeline program 416a, forwarding pipeline 420b can be configured according to custom pipeline program 416b, and forwarding pipeline 420n can be configured according to custom pipeline program 416n, etc.). Each forwarding pipeline 420a, 420b, 420n comprises its own respective ingress portion 422a, 422b, 422n and egress portion 424a, 424b, 424n. Moreover, each forwarding pipeline 420a, 420b, 420n is associated with a corresponding recirculation port 426a, 426b and 426n such that a packet forwarded to that recirculation port 426a, 426b and 426n is forwarded to the ingress portion 422a, 422b, 422n of that respective forwarding pipeline 420a, 420b, 420n.

Network device 400 can thus control the flow of packets 402 received from hosts through network interfaces 412 into and out of network device 400 by forwarding these packets 402 through or between these differently configured forwarding pipelines. Specifically, when a packet 402 is received at network device 400 from a host through a network interface 412 it may be forwarded to the ingress portion 422a of an initial (e.g., standard) forwarding pipeline 420a executing on the packet processor 430. The ingress portion 422a of the initial forwarding pipeline 420a may determine that the packet is to be forwarded to another (e.g., custom) pipeline 420b. When this determination is made, the packet 402 can be forwarded to the egress portion 424b of the subsequent forwarding pipeline 420b (Flow A), or to the recirculation port 426b associated with the subsequent pipeline such that the packet is forwarded to the ingress portion 422b of the subsequent pipeline 420b (Flow B).

Moving to FIG. 4B, if the packet 402 was forwarded to the egress portion 424b of the subsequent (e.g., custom) 420b pipeline, the egress portion 424b of the subsequent pipeline may process the packet 402 to make a decision regarding that packet 402 for forwarding the packet. The packet can then be forwarded to the recirculation port 426b such that the packet is forwarded to the ingress portion 422b of the subsequent pipeline 420b (Flow C then Flow B). After the packet is forwarded back to the ingress portion 422b of the subsequent pipeline 420b (Flow B), the ingress portion 422b of the subsequent pipeline 420b may determine that the packet 402 is to be forwarded back to the initial pipeline 420a (e.g., the standard pipeline) for processing by the initial pipeline 420a. If the packet 402 is to be forwarded back to the initial pipeline 420a, the packet 402 can be forwarded to the egress portion 424a of the initial pipeline 420a for forwarding by the egress portion 424a of the initial pipeline 420a (Flow E) or to the recirculation port 426a associated with the initial pipeline 420a such that the packet 402 is forwarded to the ingress portion 422a of the initial pipeline 420a (Flow F) for processing by the initial pipeline 420a.

When processing the packet 402, ingress portion 422b of the subsequent pipeline 420b may also determine that the packet 402 is to be forwarded to another pipeline 420 (e.g., another pipeline 420 that is not the initial pipeline 420a). FIG. 4C depicts such a scenario. When this determination is made, the packet 402 can be forwarded to the egress portion 424n of the subsequent forwarding pipeline 420n (Flow G), or to the recirculation port 426n associated with the subsequent pipeline 420n such that the packet 402 is forwarded to the ingress portion 422n of the subsequent pipeline 420n (Flow H).

This subsequent pipeline 420n can then process the packet 402 similarly to that described with respect to subsequent pipeline 420b. As depicted in FIG. 4D, if the packet 402 was forwarded to the egress portion 424n of the subsequent (e.g., custom) 420n pipeline, the egress portion 424n of the subsequent pipeline 420n may process the packet 402 to make a forwarding decision regarding that packet 402. The packet can then be forwarded to the recirculation port 426n such that the packet is forwarded to the ingress portion 422n of the subsequent pipeline 420n (Flow I then Flow H). After the packet is forwarded back to the ingress portion 422n of the subsequent pipeline 420n (Flow H), the ingress portion 422n of the subsequent pipeline 420n may process the packet 402.

The ingress portion 422n of the subsequent pipeline 420n may determine that the packet 402 is to be forwarded back to the initial pipeline 420a (e.g., the standard pipeline) for processing by the initial pipeline 420a. If the packet 402 is to be forwarded back to the initial pipeline 420a, the packet 402 can be forwarded to the egress portion 424a of the initial pipeline 420a for forwarding by the egress portion 424a of the initial pipeline 420a (Flow K) or to the recirculation port 426a associated with the initial pipeline 420a such that the packet 402 is forwarded to the ingress portion 422a of the initial pipeline 420a (Flow L) for processing by the initial pipeline 420a.

As previously discussed, in certain embodiments the packet processor of the network device implements a programmable forwarding pipeline architecture. For example, such an architecture includes a match action pipeline architecture. A match action unit may include logic and lookup tables that are used to make forwarding or packet rewriting decisions. Thus, in a match action unit subsets of data bits in the packet are matched against tables, where the matched entries in the tables specify corresponding actions that are applied to the packet. Such a match action pipeline architecture may be leveraged to efficiently forward packets between differently configured forwarding pipelines. Specifically, in such an architecture a match action stage (unit) of the ingress portion of a forwarding pipeline may be a packet forwarding stage adapted to make packet forwarding decisions to forward packets to other forwarding pipelines. A stage or unit may thus perform a discrete action associated with a packet as it is being processed by a pipeline.

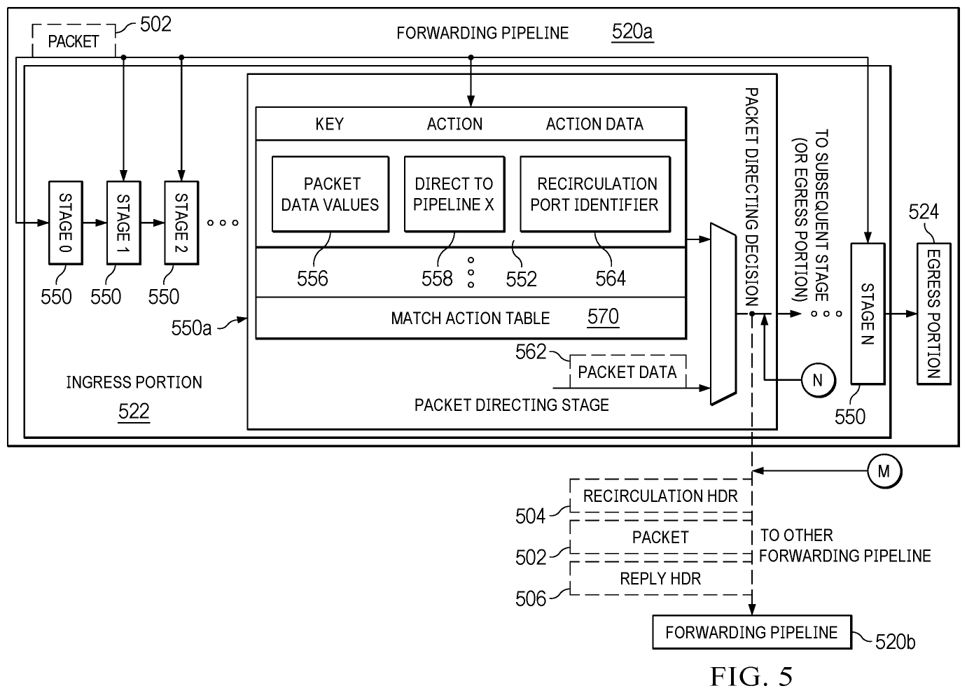

FIG. 5 is a block diagram of one embodiment of an architecture for an ingress portion of a forwarding pipeline comprising just such a packet forwarding stage. To illustrate in more detail, forwarding pipeline 520a comprises match action units (stages) 550 for implementing the forwarding pipeline 520a. Thus, ingress portion 522 of the forwarding pipeline 520a may comprise stages 550 adapted to implement the ingress portion 522 of that pipeline 520a. Packet data of packet 502 is provided to each stage 550 of the ingress portion 522 of the pipeline 520a. Data from the packet 502 can then be used to match entries 552 in a match action table of the stage to determine an action to take with respect to the packet 502 (or packet data). The match action table 570 may comprise a set of entries 552, where each entry 552 is associated with a key to match on and an action to be executed if the packet (e.g., packet data) matched the entry. Furthermore, each entry 552 may be associated with action data (e.g., that may be utilized in association with execution of the action for the corresponding entry). Thus, a key can be formed based on the data of the packet 502 and a lookup can be performed in the match action table to determine if any entries in the table are matched. The action associated with a matched entry 552 can be taken. Alternatively, a default action may be taken by the stage 550 if no entry in the table is matched.

Accordingly, one stage 550 of the ingress portion 522 of a forwarding pipeline 520a may include a packet forwarding stage 550a. This packet forwarding stage 550a may comprise a match action table 570. This match action table 570 comprises one or more packet directing entries 552 where each entry 552 comprises a key, an action and associated action data. An entry 552 may thus correspond to forwarding a packet to another pipeline (e.g., a subsequent pipeline or back to an initial pipeline). Such an entry 552 may comprise one or more values 556 for packet data that comprise the key, an action 558 for forwarding of the packet to a particular forwarding pipeline (or portion of the pipeline), and action data associated with the specified action 558. For example, the action data may include an identifier 564 of a recirculation port of the forwarding pipeline to which the packet is to be forwarded. This identifier 564 for the recirculation port can, for example, be a LAG identifier associated with the recirculation port for the forwarding pipeline to which the packet is to be forwarded.

Accordingly, when a packet 502 is being processed by the packet forwarding stage 550a a key is formed based on packet data 562 associated with the packet 502 undergoing processing by the pipeline 520a. The packet forwarding stage 550a performs a lookup in the match action table 570 based on the formed key. When a lookup in this table 570 is a match for a packet directing entry 552 based on the packet data values 556 for that entry 552, the action 558 associated with that entry 552 can be taken, and the packet 502 can be forwarded to the recirculation port for the forwarding pipeline 520b to which the packet 502 is being forwarded based on the identifier 564 for that recirculation port specified in the determined entry 552, allowing the forwarding pipeline 520b to which the packet 502 is being forwarded to process the packet 502 (Flow M). Alternatively, if no entry (or another entry is matched), the packet may be forwarded to a subsequent stage 550 of the ingress portion 522 of that forwarding pipeline 520a for further processing or forwarded to the egress portion 524 of that forwarding pipeline 520a (Flow N).

To assist the forwarding pipeline 520b to which the packet 502 is being forwarded, data associated with the packet may be appended to the packet 502 (e.g., as a header or trailer, etc.) before it is forwarded to the recirculation port of the other forwarding pipeline 520b. The determination of the data and the appending of the data may, for example, be performed as part of the action specified by a matched entry in the match action table 570. For example, if a packet is being forwarded to a subsequent (e.g., a custom) pipeline this associated data may be prepended in a recirculation header 504 or the like and may include data identifying an ingress port associated with the packet, a VLAN associated with the packet, or a classification tag associated with the packet. As another example, if the packet if being forwarded back to a forwarding pipeline 520b which has already processed the packet (e.g., an initial pipeline used to process the packet 502) a reply header 506 or the like may be prepended to (or included with) the packet, where this reply header may include a forwarding domain identifier (e.g., a VLAN encapsulation tag) or a re-run indicator indicating whether the packet 502 should (or should not) be run again through all, or certain stages of, the forwarding pipeline (e.g., the initial pipeline) to which the packet is 502 is being forwarded.

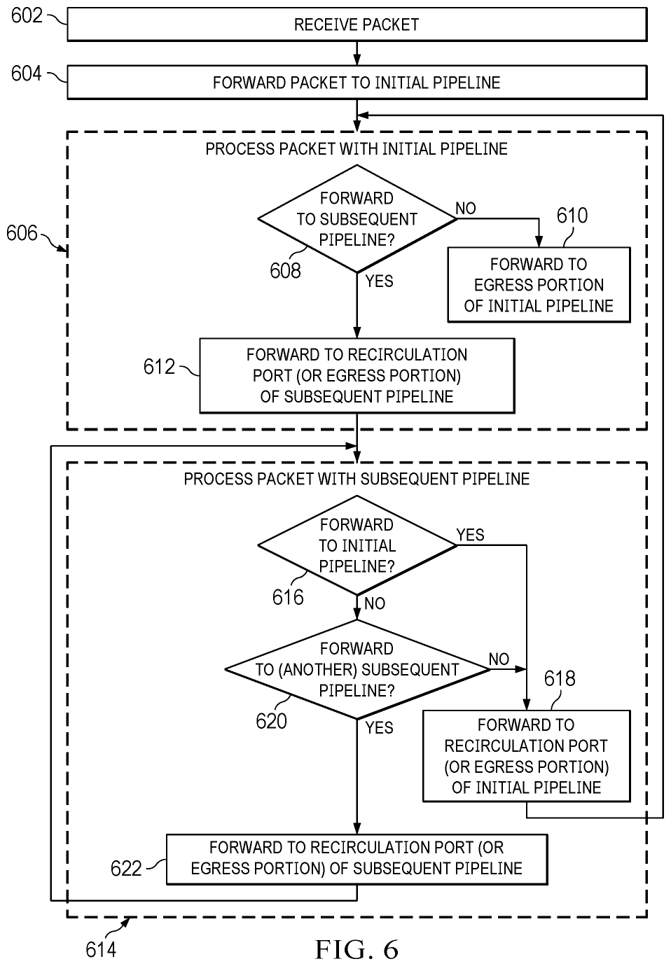

Turning now to FIG. 6, a flow diagram for an embodiment of a method that may be implemented by a network device when forwarding packets between differently configured forwarding pipelines is depicted. Initially, a packet can be received by the network device (STEP 602) and that packet forwarded to an ingress portion of an initial (e.g., standard) pipeline for processing (STEP 604). During processing of that packet by the initial pipeline (STEP 606), it can be determined if the packet is to be forwarded to another (subsequent) pipeline at the network device, where that subsequent pipeline is configured according to a different pipeline program such as a custom program created by a user of the network device (STEP 608). If no determination is made that the packet is to be forwarded to a subsequent pipeline (No branch of STEP 608), the packet may be forwarded to the egress portion of the initial pipeline (STEP 610). If, however, it is determined that the packet is to be forwarded to a subsequent pipeline (Yes branch of STEP 608), the packet can be forwarded to that subsequent pipeline. Specifically, the packet can be forwarded to the egress portion of the subsequent pipeline, or to the recirculation port associated with the subsequent pipeline such that the packet is forwarded to the ingress portion of the subsequent pipeline (STEP 612).

When the packet is forwarded to the subsequent pipeline it can then be processed by the subsequent pipeline (STEP 614). During processing of that packet by the subsequent pipeline, it can be determined if the packet is to be forwarded to another (subsequent) pipeline at the network device, (STEP 616) or if the packet is to be forwarded back to the initial pipeline (STEP 620). If the packet is to be forwarded to another subsequent pipeline (N branch of STEP 616 and Y branch of STEP 620) the packet can be forwarded to the egress portion of the subsequent pipeline or to the recirculation port associated with the subsequent pipeline such that the packet is forwarded to the ingress portion of the subsequent pipeline (STEP 622). During processing of the packet each subsequent pipeline can make similar determinations until the packet is forwarded back to the initial pipeline for processing by the egress portion of the initial pipeline. In this way, the packet can be forwarded to almost any number of subsequent (e.g., custom) pipelines for processing as desired and may still be forwarded back to the initial (e.g., standard) forwarding pipeline to be processed by the egress portion of the initial pipeline for forwarding.

Thus, when the subsequent pipeline determines the packet is to be forwarded back to the initial pipeline (Y branch of STEP 616), the packet can be forwarded to the egress portion of the initial pipeline or to the recirculation port associated with the initial pipeline such that the packet is forwarded to the ingress portion of the initial pipeline (STEP 618).

It will be understood that while specific embodiments have been presented herein, these embodiments are merely illustrative, and not restrictive. Rather, the description is intended to describe illustrative embodiments, features and functions in order to provide an understanding of the embodiments without limiting the disclosure to any particularly described embodiment, feature, or function, including any such embodiment, feature, or function described. While specific embodiments of, and examples for, the embodiments are described herein for illustrative purposes only, various equivalent modifications are possible within the spirit and scope of the disclosure, as those skilled in the relevant art will recognize and appreciate.

As indicated, these modifications may be made in light of the foregoing description of illustrated embodiments and are to be included within the spirit and scope of the disclosure. Thus, while particular embodiments are described, a latitude of modification, various changes and substitutions are intended in the foregoing disclosures, and it will be appreciated that in some instances some features of embodiments of the invention will be employed without a corresponding use of other features, and features described with respect to one embodiment may be combined with features of other embodiments without departing from the scope and spirit of the disclosure as set forth.

What is claimed is:

1. A method, comprising:
receiving a packet at a network device;
forwarding the packet to an ingress portion of a first pipeline configured at the network device according to a first pipeline program;
processing the packet with the ingress portion of the first pipeline;
determining, by the ingress portion of the first pipeline, that the packet is to be forwarded to a second pipeline configured at the network device according to a second pipeline program, wherein the second pipeline is associated with a second recirculation port such that packets received at the second recirculation port are forwarded to an ingress portion of the second pipeline;
forwarding, by the ingress portion of the first pipeline, the packet to the second pipeline; and
processing the packet by the second pipeline.

2. The method of claim 1, wherein processing the packet by the second pipeline comprises processing the packet by an egress portion of the second pipeline.

3. The method of claim 1, wherein forwarding the packet to the second recirculation port comprises appending a header to the packet, the header identifying an ingress port associated with the packet, a virtual local area network (VLAN) associated with the packet, or a classification tag associated with the packet.

4. The method of claim 1, wherein forwarding the packet to the second pipeline comprises forwarding the packet to the second recirculation port associated with the second pipeline such that the packet is forwarded from the second recirculation port to the ingress portion of the second pipeline for processing by the ingress portion of the second pipeline.

5. The method of claim 4, further comprising:
forwarding, by the ingress portion of the second pipeline, the packet to a first recirculation port associated with the first pipeline, wherein the packet is forwarded from the first recirculation port to the ingress portion of the first pipeline; and
processing the packet by the ingress portion of the first pipeline again.

6. The method of claim 5, wherein forwarding the packet to the first recirculation port comprises appending a reply header to the packet, the reply header including at least one of a re-run classification indicator or a forwarding domain identifier.

7. The method of claim 6, wherein the forwarding domain identifier is a VLAN encapsulation tag.

8. The method of claim 5, wherein the first recirculation port and the second recirculation port are internal recirculation ports and the packet is forwarded internally using the internal recirculation ports.

9. The method of claim 1, further comprising:
forwarding, by the second pipeline, the packet directly to an egress port of the network device.

10. The method of claim 1, wherein the first program is a standard pipeline program provided with the network device.

11. A network device, comprising:
a processor executing multiple pipelines for forwarding packets received at ports of the network device, the multiple pipelines including:
a first pipeline configured according to a first pipeline program, the first pipeline including an ingress portion comprising a match action unit; and
a second pipeline configured according to a second pipeline program, wherein the second pipeline is associated with a recirculation port such that packets received at the recirculation port are forwarded to the second pipeline and the match action unit of the first pipeline includes a table comprising an entry specifying an action associated with an identifier for the recirculation port associated with the second pipeline;
the processor adapted for:
receiving a packet at a port of the network device;
determining packet data associated with the packet;
processing the packet with the ingress portion of the first pipeline based on the packet data;
determining, by the match action unit of the first pipeline, that the packet is to be forwarded to the second pipeline, wherein determining that the packet is to be forwarded to the second pipeline comprises forming a key based on the packet data and performing a lookup in the table based on the key to determine the entry;
forwarding, by the ingress portion of the first pipeline, the packet to the second pipeline; and
processing the packet by the second pipeline.

12. The network device of claim 11, wherein the processor is adapted for:
determining, by a match action unit of the second pipeline, that the packet is to be forwarded to a third pipeline; and
forwarding, by an ingress portion of the second pipeline, the packet to the third pipeline.

13. The network device of claim 12, wherein the processor is adapted for:
forwarding, by an ingress portion of the third pipeline, the packet to a first recirculation port associated with the first pipeline, wherein the packet is forwarded from the first recirculation port associated with the first pipeline to the ingress portion of the first pipeline.

14. The network device of claim 11, wherein processing the packet by the second pipeline comprises processing the packet by an egress portion of the second pipeline.

15. The network device of claim 11, wherein forwarding the packet to the second pipeline comprises forwarding the packet to the second recirculation port associated with the second pipeline based on the identifier for the recirculation port specified in the action of the determined entry such that the packet is forwarded from the second recirculation port to an ingress portion of the second pipeline for processing by the ingress portion of the second pipeline.

16. The network device of claim 15, wherein the processor is adapted for:
determining, by a match action unit of the ingress portion of the second pipeline, that the packet is to be forwarded to the first pipeline; and
forwarding, by the ingress portion of the second pipeline, the packet to a first recirculation port associated with the first pipeline, wherein the packet is forwarded from the first recirculation port to the ingress portion of the first pipeline.

17. The network device of claim 11, wherein the identifier for the recirculation port comprises a link aggregation group (LAG) identifier associated with the recirculation port.

18. The network device of claim 11, wherein the recirculation port is a loopback port of the network device and the packet is forwarded using the loopback port.

19. A network device, comprising:
a processor configured with multiple distinct pipelines, the processor adapted for:
receiving a packet at an ingress portion of a first pipeline of the multiple distinct pipelines;
processing the packet with the ingress portion of the first pipeline;
determining that the packet is to be forwarded to a second pipeline of the multiple distinct pipelines;
forwarding the packet from the ingress portion of the first pipeline to the second pipeline;
processing the packet by the second pipeline;
determining that the packet is to be forwarded back to the first pipeline of the multiple distinct pipelines;
forwarding the packet from an ingress portion of the second pipeline to the first pipeline; and
processing the packet with the first pipeline again.

20. The network device of claim 19, wherein forwarding the packet from the ingress portion of the second pipeline to the first pipeline comprises forwarding the packet to an egress portion of the first pipeline for forwarding of the packet to a network interface of the network device.
